(19) United States
(12) Patent Application Publication
(10) Pub. No.: US 2025/0046804 A1
(43) Pub. Date: Feb. 6, 2025

(54) POSITIVE ELECTRODE ACTIVE MATERIAL PARTICLE, POSITIVE ELECTRODE, AND LITHIUM-ION BATTERY

(71) Applicant: TOYOTA JIDOSHA KABUSHIKI KAISHA, Toyota-shi Aichi-ken (JP)

(72) Inventor: Kenji Yokoe, Okazaki-shi Aichi ken (JP)

(73) Assignee: TOYOTA JIDOSHA KABUSHIKI KAISHA, Toyota-shi Aichi-ken (JP)

(21) Appl. No.: 18/788,739

(22) Filed: Jul. 30, 2024

(30) Foreign Application Priority Data
Aug. 4, 2023 (JP) 2023-127491

(51) Int. Cl. H01M 4/485; H01M 4/02; H01M 4/62; H01M 10/0525

(52) U.S. Cl. CPC H01M 4/485; H01M 4/625; H01M 10/0525; H01M 2004/021; H01M 2004/028

(57) ABSTRACT

A positive electrode active material particle, wherein the positive electrode active material particle has a crystal structure of lamellar rock salt type, the positive electrode active material particle includes a magnesium-containing lithium composite oxide, and a magnesium concentration in an internal portion of the positive electrode active material particle is higher than a magnesium concentration in a surface portion of the positive electrode active material particle.

### CROSS REFERENCE TO RELATED APPLICATIONS

This nonprovisional application is based on Japanese Patent Application No. 2023-127491 filed on Aug. 4, 2023, with the Japan Patent Office, the entire contents of which are hereby incorporated by reference.

### BACKGROUND OF THE DISCLOSURE

### Technical Field

The present disclosure relates to a positive electrode active material particle, a positive electrode, and a lithium-ion battery.

### Description of the Background Art

Japanese Patent Laying-Open No. 2018-88383 discloses a positive electrode active material for a non-aqueous electrolyte secondary battery, in which the positive electrode active material includes magnesium (Mg) and it has a concentration gradient of the Mg concentration decreasing from the surface of the particle toward the center.

### SUMMARY OF THE DISCLOSURE

When the Mg concentration is high at the surface of the particle, it inhibits lithium (Li) diffusion and also inhibits electron conduction, among others, and thereby resistance, especially initial resistance can be increased. Moreover, when Mg is present only at the surface of the particle, the degree of extension/shrinkage of the c-axis length that occurs along with charging and discharging is different between outer and inner parts of the positive electrode active material, which can cause formation of cracks in the internal portion, potentially leading to degradation of capacity retention.

An object of the present disclosure is to inhibit an increase of initial resistance and to inhibit degradation of capacity retention.

[1] A positive electrode active material particle, wherein
the positive electrode active material particle has a crystal structure of lamellar rock salt type,
the positive electrode active material particle includes a magnesium-containing lithium composite oxide, and
a magnesium concentration in an internal portion of the positive electrode active material particle is higher than a magnesium concentration in a surface portion of the positive electrode active material particle.

When the Mg concentration is higher in the internal portion than in the surface portion, it is conceivable that inhibition of Li diffusion, inhibition of electron conduction, and/or the like can be less influential and, as a result, an increase of initial resistance can be inhibited. It is also conceivable that because Mg is included, extension of the c-axis length of the positive electrode active material particle that can occur along with charging and discharging can be inhibited and, thereby, formation of cracks in the internal portion can be inhibited, resulting in less degradation of capacity retention.

[2] The positive electrode active material particle according to [1], wherein
the magnesium concentration in the internal portion is from 0.5 mol % to 8.0 mol %, and
the magnesium concentration in the surface portion is 5.0 mol % or less.

[3] The positive electrode active material particle according to [1] or [2], wherein a difference between the magnesium concentration in the internal portion and the magnesium concentration in the surface portion is 1.0 mol % or more.

[4] A positive electrode comprising the positive electrode active material particle according to any one of [1] to [3].

[5] The positive electrode according to [4], further comprising carbon nanotubes.

[6] A lithium-ion battery comprising the positive electrode according to [4] or [5].

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a cross-sectional view of a positive electrode active material particle according to the present embodiment.

FIG. 2 is a conceptual view illustrating an example of a lithium-ion battery according to the present embodiment.

FIG. 3 is a table showing a first battery configuration.

FIG. 4 is a table showing a second battery configuration.

FIG. 5 is a table showing a third battery configuration.

FIG. 6 is a table showing configurations of samples in Examples and Comparative Examples, as well as evaluation results.

### DESCRIPTION OF THE EMBODIMENTS

Next, an embodiment of the present disclosure (which may also be simply called “the present embodiment” hereinafter) and an example of the present disclosure (which may also be simply called “the present example” hereinafter) will be described. It should be noted that neither the present embodiment nor the present example limits the technical scope of the present disclosure.

A stoichiometric composition formula represents a typical example of a compound. A compound may have a non-stoichiometric composition. For example, “Al₂O₃” is not limited to a compound where the ratio of the amount of substance (molar ratio) is “Al/O=2/3”. “Al₂O₃” represents a compound that includes Al and O in any composition ratio, unless otherwise specified. Further, the compound may be doped with a trace element, or some of Al and/or O may be replaced by another element, for example.

“Derivative” refers to a compound that is derived from its original compound by at least one partial modification selected from the group consisting of functional group introduction, atom replacement, oxidation, reduction, and other chemical reactions. The position of modification may be one position, or may be a plurality of positions. “Substituent” may include, for example, at least one selected from the group consisting of alkyl group, alkenyl group, alkynyl group, cycloalkyl group, unsaturated cycloalkyl group, aromatic group, heterocyclic group, halogen atom (F, Cl, Br, I, etc.), OH group, SH group, CN group, SCN group, OCN group, nitro group, alkoxy group, unsaturated alkoxy group, amino group, alkylamino group, dialkylamino group, aryloxy group, acyl group, alkoxycarbonyl group, acyloxy group, aryloxycarbonyl group, acylamino group, alkoxycarbonylamino group, aryloxy carbonylamino group, sulfonylamino group, sulfamoyl group, carbamoyl group, alkylthio group, arylthio group, sulfonyl group, sulfinyl group, ureido group, phosphoramide group, sulfo group, carboxy group, hydroxamic acid group, sulfino group, hydrazino group, imino group, silyl group, and the like. These substituents may be further substituted. When there are two or more substituents, these substituents may be the same as one another or may be different from each other. A plurality of substituents may be bonded together to form a ring.

“Copolymer” includes at least one selected from the group consisting of unspecified-type, statistical-type, random-type, alternating-type, periodic-type, block-type, and graft-type.

### <<Positive Electrode Active Material Particle>>

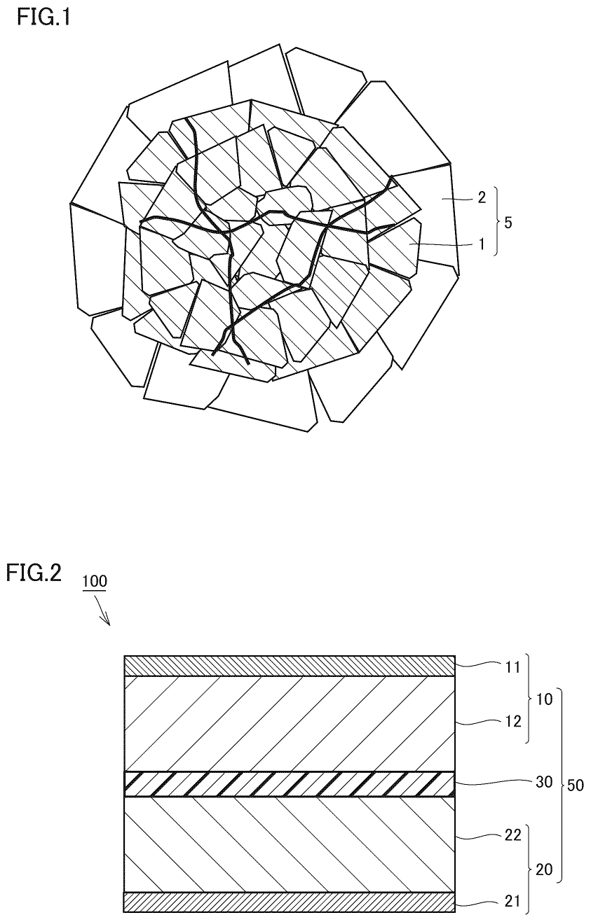

FIG. 1 is a cross-sectional view of a positive electrode active material particle according to the present embodiment. A positive electrode active material particle 5 has a crystal structure of lamellar rock salt type. Positive electrode active material particle 5 includes a Mg-containing lithium composite oxide. The Mg concentration in an internal portion 1 of positive electrode active material particle 5 is higher than the Mg concentration in a surface portion 2 of positive electrode active material particle 5.

Positive electrode active material particle 5 has a crystal structure of lamellar rock salt type. The crystal structure of positive electrode active material particle 5 may be identified by Inductively Coupled Plasma Atomic Emission Spectroscopy (ICP-AES), for example.

Positive electrode active material particle 5 includes a Mg-containing lithium composite oxide. The Mg-containing lithium composite oxide is not limited in its composition as long as positive electrode active material particle 5 has a crystal structure of lamellar rock salt type.

The Mg concentration (mol %) in internal portion 1 of positive electrode active material particle 5 is higher than the Mg concentration (mol %) in surface portion 2 of positive electrode active material particle 5. In other words, the composition of internal portion 1 of positive electrode active material particle 5 is different from that of surface portion 2. When the Mg concentration in internal portion 1 of positive electrode active material particle 5 is increased, it is expected that inhibition of Li diffusion, inhibition of electron conduction, and/or the like can be less influential and, as a result, an increase of initial resistance can be inhibited. It is also expected that extension of the c-axis length of positive electrode active material particle 5 that can occur along with charging and discharging can be inhibited and, thereby, formation of cracks in internal portion 1 can be inhibited, resulting in less degradation of capacity retention. The Mg concentration in internal portion 1 of positive electrode active material particle 5 is not particularly limited as long as it is higher than Mg in surface portion 2 of positive electrode active material particle 5, and, for example, the Mg concentration in surface portion 2 of positive electrode active material particle 5 may be 0 mol %. Moreover, the Mg concentration of positive electrode active material particle 5 may increase continuously from surface portion 2 of positive electrode active material particle 5 toward internal portion 1, for example.

In the present embodiment, “the internal portion of the positive electrode active material particle” refers to a region at and near the center of gravity of the positive electrode active material particle, and, typically, it refers to a region that is 100 nm or more inward from the outermost surface of the positive electrode active material particle toward the center of gravity. For example, when the positive electrode active material particle is a substantially spherical particle, a smallest circle circumscribing the particle is drawn and the region spanning up to 100 nm from the center of gravity can be regarded as the internal portion of the positive electrode active material particle. “The surface portion of the positive electrode active material particle” refers to a region spanning up to 50 nm inward from the surface of the positive electrode active material particle.

For example, the composition of internal portion 1 of the Mg-containing lithium composite oxide is represented by the following formula (1).

LiₐNi_{(1-b)}Mg_{b}O_{c} (1)

In the above formula (1), a satisfies the relationship of 1.00≤a≤1.20, b satisfies the relationship of 0.005≤b≤0.08, and c satisfies the relationship of 2.0≤c≤2.1. In some embodiments, b is 0.01≤b≤0.06, and it may be 0.02≤b≤0.05.

For example, the composition of surface portion 2 of the Mg-containing lithium composite oxide is represented by the following formula (2).

LiₓNi_{(1-y)}Mg_{y}O_{z} (2)

In the above formula (2), x satisfies the relationship of 1.00≤x≤1.20, y satisfies the relationship of 0.00≤y≤0.05, and z satisfies the relationship of 2.0≤z≤2.1. For example, y may be 0.001≤y≤0.05, or may be 0.002≤y≤0.04.

The Mg concentration in internal portion 1 and in surface portion 2 of positive electrode active material particle 5 according to the present embodiment can be checked by Transmission Electron Microscope (TEM)-Energy Dispersive X-ray Spectroscopy (EDX), for example. More specifically, a measurement target is prepared first, by embedding a positive electrode active material particle 5 in a proper resin and subjecting it to cross-section polisher processing and/or the like to expose a cross section of positive electrode active material particle 5. Then, this cross section is examined by TEM at a proper magnification. In the TEM examination image thus obtained, the center of gravity and the outermost surface of positive electrode active material particle 5 are analyzed by EDX to determine the concentration (mol %) of Mg atoms in respective portions. In some embodiments, EDX line analysis may be performed along a straight line that extends from a point on the outermost surface of positive electrode active material particle 5 toward the center of gravity. The line analysis makes it possible to precisely track the change of the concentration of Mg atoms from the surface of positive electrode active material particle 5 to the center of gravity.

In some embodiments, the Mg concentration in internal portion 1 of positive electrode active material particle 5 may be from 0.5 mol % to 8.0 mol %, from 1.0 mol % to 6.0 mol %, or from 2.0 mol % to 5.0 mol %. In some embodiments, the Mg concentration in surface portion 2 of positive electrode active material particle 5 may be 5.0 mol % or less, from 0.1 mol % to 5.0 mol %, or from 0.2 mol % to 4.0 mol %.

In some embodiments, the difference between the Mg concentration in internal portion 1 of positive electrode active material particle 5 and the Mg concentration in surface portion 2 of positive electrode active material particle 5 is 1.0 mol % or more. When the difference satisfies the above-mentioned range, both the inhibition of initial resistance increase and the inhibition of capacity retention degradation can be further achieved. In some embodiments, the difference between the Mg concentration in internal portion 1 of positive electrode active material particle 5 and the Mg concentration in surface portion 2 of positive electrode active material particle 5 may be 2.0 mol % or more, or 2.5 mol % or more, or 3.0 mol % or more. It should be noted that from the viewpoint of production of positive electrode active material particle 5, it may be 5.0 mol % or less, for example.

The crystallite diameter of positive electrode active material particle 5 may be from 450 Å to 900 Å. Herein, a crystallite refers to a region (a lump), in the crystal structure of a single positive electrode active material particle 5, that can be regarded as a single crystal, and the crystallite diameter refers to the size of the crystallite. As the crystallite diameter, a value calculated from X-ray diffraction (XRD) line profile by the Scherrer equation can be used. As the crystallite diameter of positive electrode active material particle 5 according to the present embodiment, the crystallite diameter based on a (003) plane that appears as a main peak in the X-ray diffraction line profile can be used. For example, the crystallite diameter of positive electrode active material particle 5 may be obtained by calculating, by the Scherrer equation, the half width of a (003) plane that is observed within the range of 20=19.1 to 20.1 of the spectrum obtained by XRD measurement.

Typically, positive electrode active material particle 5 is a secondary particle formed of primary particles aggregated together. For example, positive electrode active material particle 5 may have an average particle size (D50) from 4.0 μm to 8.0 μm, or may have a D50 from 5.0 μm to 7.0 μm. Herein, D50 refers to a particle size in volume-based particle size distribution at which the cumulative frequency accumulated from the small particle size side reaches 50%. D50 may be measured by laser diffraction.

The shape of positive electrode active material particle 5 is not particularly limited; for example, it may be substantially spherical, flake-shaped, columnar, and/or the like, and, in some embodiments, it is substantially spherical. “Substantially spherical” is a term that encompasses spherical, rugby ball-shape, polygonal, and the like, and, for example, it refers to a shape having an average aspect ratio (which is the ratio of the long-axis length to the short-axis length of a smallest rectangular circumscribing the particle) from 1 to 2.

Positive electrode active material particle 5 may include a transition metal oxide, a polyanion compound, and/or the like, for example.

### <Transition Metal Oxide: Space Group R-3m>

The transition metal oxide may have any crystal structure. For example, the transition metal oxide may include a crystal structure that belongs to a space group R-3m and/or the like. For example, a compound represented by the general formula “LiMO₂” may have a crystal structure that belongs to a space group R-3m. The transition metal oxide may be represented by the following formula (A-1), for example.

Li₁₋ₐNiₓM₁₋ₓO₂ (A-1)

In the above formula, the relationships of −0.5≤a≤0.5, 0≤x≤1 are satisfied. M may include, for example, at least one selected from the group consisting of Co, Mn, and Al.

In the above formula (A-1), x may satisfy the relationship of 0≤x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x≤1, for example, a may satisfy the relationship of −0.4≤a≤0.4, −0.3≤a≤0.3, −0.2≤a≤0.2, or −0.1≤a≤0.1, for example.

The transition metal oxide may include, for example, at least one selected from the group consisting of LiCoO₂, LiMnO₂, LiNi_{0.9}Co_{0.1}O₂, LiNi_{0.9}Mn_{0.1}O₂, and LiNiO₂.

### <NCM>

The transition metal oxide may be represented by the following formula (A-2), for example. A compound represented by the following formula (A-2) may also be called “NCM”.

Li₁₋ₐNiₓCo_{y}Mn_{z}O₂ (A-2)

In the above formula, the relationships of −0.5≤a≤0.5, 0<x<1, 0<y<1, 0<z<1, x+y+z=1 are satisfied.

In the above formula (A-2), x may satisfy the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x≤1, for example.

In the above formula (A-2), y may satisfy the relationship of 0≤y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y≤1, for example.

In the above formula (A-2), z may satisfy the relationship of 0≤z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z≤1, for example.

NCM may include, for example, at least one selected from the group consisting of LiNi_{1/3}Co_{1/3}Mn_{1/3}O₂, LiNi_{0.4}Co_{0.3}Mn_{0.3}O₂, LiNi_{0.3}Co_{0.4}Mn_{0.3}O₂, LiNi_{0.3}Co_{0.3}Mn_{0.4}O₂, LiNi_{0.5}Co_{0.2}Mn_{0.3}O₂, LiNi_{0.5}Co_{0.3}Mn_{0.2}O₂, LiNi_{0.5}Co_{0.4}Mn_{0.1}O₂, LiNi_{0.5}Co_{0.1}Mn_{0.4}O₂, LiNi_{0.6}Co_{0.2}Mn_{0.2}O₂, LiNi_{0.6}Co_{0.3}Mn_{0.1}O₂, LiNi_{0.6}CO_{0.1}Mn_{0.3}O₂, LiNi_{0.7}Co_{0.1}Mn_{0.2}O₂, LiNi_{0.7}Co_{0.2}Mn_{0.1}O₂, LiNi_{0.8}Co_{0.1}Mn_{0.1}O₂, and LiNi_{0.9}Co_{0.05}Mn_{0.05}O₂.

### <NCA>

The transition metal oxide may be represented by the following formula (A-3), for example. A compound represented by the following formula (A-3) may also be called “NCA”.

Li₁₋ₐNiₓCo_{y}Al₂O₂ (A-3)

In the above formula, the relationships of −0.5≤a≤0.5, 0<x<1, 0<y<1, 0<z<1, x+y+z=1 are satisfied.

In the above formula (A-3), x may satisfy the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x≤1, for example.

In the above formula (A-3), y may satisfy the relationship of 0≤y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y≤1, for example.

In the above formula (A-3), z may satisfy the relationship of 0≤z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z≤1, for example.

NCA may include, for example, at least one selected from the group consisting of LiNi_{0.7}Co_{0.1}Al_{0.2}O₂, LiNi_{0.7}Co_{0.2}Al_{0.1}O₂, LiNi_{0.8}Co_{0.1}Al_{0.1}O₂, LiNi_{0.8}Co_{0.17}Al_{0.03}O₂, LiNi_{0.8}Co_{0.15}Al_{0.05}O₂, and LiNi_{0.9}Co_{0.05}Al_{0.05}O₂.

### <Multi-Component System>

Positive electrode active material particle 5 may include two or more NCMs and/or the like, for example. Positive electrode active material particle 5 may include NCM (0.6≤x) and NCM (x<0.6), for example. “NCM (0.6≤x)” refers to a compound in which x (Ni ratio) in the above formula (A-2) is 0.6 or more. NCM (0.6≤x) may also be called “a high-nickel material”, for example. NCM (0.6≤x) includes LiNi_{0.8}CO_{0.1}Mn_{0.1}O₂ and/or the like, for example. “NCM (x<0.6)” refers to a compound in which x (Ni ratio) in the above formula (A-2) is less than 0.6. NCM (x<0.6) includes LiNi_{1/3}Co_{1/3}Mn_{1/3}O₂ and/or the like, for example. The mixing ratio (mass ratio) between NCM (0.6≤x) and NCM (x<0.6) may be “NCM (0.6≤x)/NCM (x<0.6)=9/1 to 1/9”, or “NCM (0.6≤x)/NCM (x<0.6)=9/1 to 4/6”, or “NCM (0.6≤x)/NCM (x<0.6)=9/1 to 3/7”, for example.

Positive electrode active material particle 5 may include NCA and NCM, for example. The mixing ratio (mass ratio) between NCA and NCM may be “NCA/NCM=9/1 to 1/9”, “NCA/NCM=9/1 to 4/6”, or “NCA/NCM=9/1 to 3/7”, for example. Between NCA and NCM, the Ni ratio may be the same or may be different. The Ni ratio of NCA may be more than the Ni ratio of NCM. The Ni ratio of NCA may be less than the Ni ratio of NCM.

### <Transition Metal Oxide: Space Group C2/m>

The transition metal oxide may include a crystal structure that belongs to a space group C2/m and/or the like, for example. The transition metal oxide may be represented by the following formula (A-4), for example.

Li₂MO₃ (A-4)

In the above formula, M may include, for example, at least one selected from the group consisting of Ni, Co, Mn, and Fe.

Positive electrode active material particle 5 may include a mixture of LiMO₂ (space group R-3m) and Li₂MO₃ (space group C2/m), for example. Positive electrode active material particle 5 may include a solid solution that is formed of LiMO₂ and Li₂MO₃ (Li₂MO₃-LiMO₂), and/or the like, for example.

### <Transition Metal Oxide: Space Group Fd-3m>

The transition metal oxide may include a crystal structure that belongs to a space group Fd-3m, and/or the like, for example. The transition metal oxide may be represented by, for example, the following formula (A-5).

LiMn₂₋ₓMₓO₄ (A-5)

In the above formula, the relationship of 0≤x≤2 is satisfied.

M may include, for example, at least one selected from the group consisting of Ni, Fe, and Zn.

LiM₂O₄ (space group Fd-3m) may include, for example, at least one selected from the group consisting of LiMn₂O₄ and LiMn_{1.5}Ni_{0.5}O₄. Positive electrode active material particle 5 may include a mixture of LiMO₂ (space group R-3m) and LiM₂O₄ (space group Fd-3m), for example. The mixing ratio (mass ratio) between LiMO₂ (space group R-3m) and LiM₂O₄ (space group Fd-3m) may be “LiMO₂/LiM₂O₄=9/1 to 9/1”, or “LiMO₂/LiM₂O₄=9/1 to 5/5”, or “LiMO₂/LiM₂O₄=9/1 to 7/3”, for example.

### <Polyanion Compound>

The polyanion compound may include a phosphoric acid salt (such as LiFePO₄ for example), a silicic acid salt, a boric acid salt, and/or the like, for example. The polyanion compound may be represented by the following formulae (A-6) to (A-9), for example.

LIMPO₄ (A-6)

Li₂₋ₓMPO₄F (A-7)

Li₂MSiO₄ (A-8)

LIMBO₃ (A-9)

In the above formulae (A-6) to (A-9), M may include, for example, at least one selected from the group consisting of Fe, Mn, and Co. In the above formula (A-7), the relationship of 0≤x≤2 may be satisfied, for example.

Positive electrode active material particle 5 may include a mixture of LiMO₂ (space group R-3m) and the polyanion compound, for example. The mixing ratio (mass ratio) between LiMO₂ (space group R-3m) and the polyanion compound may be “LiMO₂/(polyanion compound)=9/1 to 9/1”, or “LiMO₂/(polyanion compound)=9/1 to 5/5”, or “LiMO₂/(polyanion compound)=9/1 to 7/3”, for example.

### <Dopant>

To positive electrode active material particle 5, a dopant may be added. The dopant may be diffused throughout the entire particle, or may be locally distributed. For example, the dopant may be locally distributed on the particle surface. The dopant may be a substituted solid solution atom, or may be an intruding solid solution atom. The amount of the dopant to be added (the molar fraction relative to the total amount of positive electrode active material particle 5) may be from 0.01 to 5%, or may be from 0.1 to 3%, or may be from 0.1 to 1%, for example. A single type of dopant may be added, or two or more types of dopant may be added. The two or more dopants may form a complex.

The dopant may include, for example, at least one selected from the group consisting of B, C, N, a halogen, Si, Na, Mg, Al, Mn, Co, Cr, Sc, Ti, V, Cu, Zn, Ga, Ge, Se, Sr, Y, Zr, Nb, Mo, In, Pb, Bi, Sb, Sn, W, La, Ce, Pr, Nd, Pm, Sm, Eu, Gd, Tb, Dy, Ho, Er, Tm, Yb, Lu, and an actinoid.

For example, to NCA, a combination of “Zr, Mg, W, Sm”, a combination of “Ti, Mn, Nb, Si, Mo”, or a combination of “Er, Mg” may be added.

For example, to NCM, Ti may be added. For example, to NCM, a combination of “Zr, W”, a combination of “Si, W”, or a combination of “Zr, W, Al, Ti, Co” may be added.

### <Surface Coating>

The positive electrode may include a composite particle. The composite particle includes a core particle and a covering layer. The core particle includes positive electrode active material particle 5. The covering layer covers at least part of the surface of the core particle. The covering layer may have a thickness from 1 to 3000 nm, or from 5 to 2000 nm, or from 10 to 1000 nm, or from 10 to 100 nm, or from 10 to 50 nm, for example. The thickness of the covering layer may be measured in an SEM (Scanning Electron Microscope) image of a cross section of the particle, and/or the like, for example. More specifically, the composite particle is embedded in a resin material to prepare a sample. With the use of an ion milling apparatus, a cross section of the sample is exposed. For example, an ion milling apparatus with the trade name “ArBlade (registered trademark) 5000” manufactured by Hitachi High-Technologies (or a similar product) may be used. The cross section of the sample is examined by an SEM. For example, an SEM apparatus with the trade name “SU8030” manufactured by Hitachi High-Technologies (or a similar product) may be used. For each of ten composite particles, the thickness of the covering layer is measured in twenty fields of view. The arithmetic mean of a total of 200 thickness measurements is used.

The ratio of the part of the surface of the core particle covered by the covering layer is also called “a covering rate”. The covering rate may be 1% or more, or 10% or more, or 30% or more, or 50% or more, or 70% or more, for example. The covering rate may be 100% or less, or 90% or less, or 80% or less, for example.

For example, the covering rate may be measured by XPS (X-ray Photoelectron Spectroscopy). For example, an XPS apparatus with the trade name “PHI X-tool” manufactured by ULVAC-PHI (or a similar product) may be used. A sample powder consisting of the composite particle is loaded in the XPS apparatus. Narrow scan analysis is carried out. The measurement data is processed with an analysis software. For example, an analysis software with the trade name “MulTiPak” manufactured by ULVAC-PHI (or a similar product) may be used. The measurement data is analyzed to detect a plurality of types of elements. From the area of each peak, the ratio of the detected element is determined. By the following equation, the covering rate is determined.

$$θ = \{ {I}_{1} / ( {I}_{0} + {I}_{1} ) \} \times 100$$

θ: Covering rate [%]
I₀: Ratio of element attributable to core particle
I₁: Ratio of element attributable to covering layer

For example, when the core particle includes NCM, I₀ represents the total ratio of the elements “Ni, Co, Mn”. For example, when the core particle includes NCA, I₀ represents the total ratio of the elements “Ni, Co, Al”. For example, when the covering layer includes P and B, I₁ represents the total ratio of the elements “P, B”.

The covering layer may include any component. The covering layer may include an elementary substance, organic matter, an inorganic acid salt, an organic acid salt, a hydroxide, an oxide, a carbide, a nitride, a sulfide, a halide, and/or the like, for example. The covering layer may include, for example, at least one selected from the group consisting of B, Al, W, Zr, Ti, Co, F, lithium compound (such as Li₂CO₃, LiHCO₃, LiOH, Li₂O, for example), tungsten oxide (such as WO₃, for example), titanium oxide (such as TiO₂, for example), zirconium oxide (such as ZrO₂, for example), boron oxide, boron phosphate (such as BPO₄, for example), aluminum oxide (such as Al₂O₃, for example), boehmite, aluminum hydroxide, phosphoric acid salt [such as Li₃PO₄, (NH₄)₃PO₄, AlPO₄, for example], boric acid salt (such as Li₂B₄O₇, LiBO₃, for example), polyacrylic acid salt (such as Li salt, Na salt, NH₄ salt), acetic acid salt (such as Li salt, for example), CMC (such as acid type, Na salt, Li salt, NH₄ salt), LiNbO₃, Li₂TiO₃, and Li-containing halide (such as LiAlCl₄, LiTiAlF₆, LiYBr₆, LiYCl₆, for example).

### <Hollow Particles, Solid Particles>

“Hollow particle” refers to a secondary particle in which, in a cross-sectional image thereof, the proportion of the area of the central cavity is 30% or more of the entire cross-sectional area of the particle. The proportion of the cavity in a hollow particle may be 40% or more, or 50% or more, or 60% or more, for example. “Solid particle” refers to a secondary particle in which, in a cross-sectional image of the particle, the proportion of the area of the central cavity is less than 30% of the entire cross-sectional area of the particle. The proportion of the cavity in a solid particle may be 20% or less, or 10% or less, or 5% or less, for example. Positive electrode active material particle 5 may be hollow particles, or may be solid particles. A mixture of hollow particles and solid particles may be used. The mixing ratio (mass ratio) between hollow particles and solid particles may be “(hollow particles)/(solid particles)=1/9 to 9/1”, or “(hollow particles)/(solid particles)=2/8 to 8/2”, or “(hollow particles)/(solid particles)=3/7 to 7/3”, or “(hollow particles)/(solid particles)=4/6 to 6/4”, for example.

### <Large Particles/Small Particles>

“Electrode active material” collectively refers to a positive electrode active material and a negative electrode active material. The electrode active material may have a unimodal particle size distribution (based on the number), for example. The electrode active material may have a multimodal particle size distribution, for example. The electrode active material may have a bimodal particle size distribution, for example. That is, the electrode active material may include large particles and small particles. When the particle size distribution is bimodal, the particle size corresponding to the peak top of the larger particle size is regarded as the particle size of the large particles (d_{L}). The particle size corresponding to the peak top of the smaller particle size is regarded as the particle size of the small particles (d_{S}). The particle size ratio (d_{L}/d_{S}) may be from 2 to 10, or from 2 to 5, or from 2 to 4, for example. d_{L} may be from 8 to 20 μm, or from 8 to 15 μm, for example. d_{S} may be from 1 to 10 μm, or from 1 to 5 μm, for example.

For example, with the use of a waveform analysis software, peak separating processing may be carried out for the particle size distribution. The ratio between the peak area of the large particles (S_{L}) and the peak area of the small particles (S_{S}) may be “S_{L}/S_{S}=1/9 to 9/1”, or “S_{L}/S_{S}=5/5 to 9/1”, or “S_{L}/S_{S}=7/3 to 9/1”, for example.

The number-based particle size distribution is measured by a microscope method. From the electrode active material layer, a plurality of cross-sectional samples are taken. The cross-sectional sample may include a cross section vertical to the surface of the electrode active material layer, for example. By ion milling and/or the like, for example, cleaning is carried out to the side that is to be observed. By SEM, the cross-sectional sample is examined. The magnification for the examination is adjusted in such a way that 10 to 100 particles are contained within the examination field of view. The Feret diameters of all the particles in the image are measured. “Feret diameter” refers to the distance between two points located farthest apart from each other on the outline of the secondary particle. The plurality of the cross-sectional samples are examined to obtain a total of 1000 or more Feret diameters. From the 1000 or more Feret diameters, number-based particle size distribution is created.

The bimodal particle size distribution may be formed by two types of particles mixed together. These two types of particles have different particle size distributions. For example, the two types of particles may have different D50. “D50” refers to a particle size in volume-based particle size distribution at which the cumulative frequency accumulated from the side of small particle sizes reaches 50%. D50 may be measured by laser diffraction. The sample to be measured is powder. For example, the large particles may have a D50 from 8 to 20 μm, or from 8 to 15 μm. For example, the small particles may have a D50 from 1 to 10 μm, or from 1 to 5 μm. The ratio of the D50 of the large particles to the D50 of the small particles may be from 2 to 10, or from 2 to 5, or from 2 to 4, for example. The mixing ratio (mass ratio) between the large particles and the small particles may be “(large particles)/(small particles)=1/9 to 9/1”, or “(large particles)/(small particles)=5/5 to 9/1”, or “(large particles)/(small particles)=7/3 to 9/1”, for example.

The large particles and the small particles may have the same composition, or may have different compositions. For example, the large particles may be NCA and the small particles may be NCM. For example, the large particles may be NCM (0.6≤x) and the small particles may be NCM (x<0.6).

### <<Method of Producing Positive Electrode Active Material Particle>>

As a method of producing a positive electrode active material particle according to the present embodiment, the below-described method can be mentioned, for example. The below description is given as an example and does not limit the scope of the production method.

The method of producing a positive electrode active material particle according to the present embodiment includes “(A) preparation of a precursor” and “(B) calcination”, for example.

### <(A) Preparation of Precursor>

The present production method includes preparing a precursor of a positive electrode active material particle. The method for preparing the precursor is not particularly limited. For example, a mixed hydroxide of Mg and a transition metal (such as Ni, for example) is prepared. For example, powder of the mixed hydroxide is pulverized in a mortar. For example, the pulverized powder of the mixed hydroxide is dissolved in an aqueous alkali solution, and thereby a mixed solution is formed. For example, the aqueous alkali solution may include an aqueous NaOH solution, an aqueous ammonia solution, and the like. For example, to the mixed solution, an aqueous acidic solution and an aqueous alkali solution are added dropwise at the same time, and thereby a sediment may be formed. During the dropwise addition, pH may be adjusted. It is conceivable that the sediment includes a composite hydroxide (a precursor). The sediment is rinsed and dried, and thereby a dried product is formed.

Alternatively, a sulfate of Mg and a transition metal (such as Ni, for example) is prepared. The sulfate is dissolved in water, and thereby an aqueous acidic solution is formed. For example, to the aqueous acidic solution, an aqueous alkali solution is added dropwise, and thereby a neutralization reaction may occur. For example, the aqueous alkali solution may include an aqueous NaOH solution, an aqueous ammonia solution, and the like. By the neutralization reaction, a sediment may be formed. During the neutralization reaction, pH may be adjusted. It is conceivable that the sediment includes a precursor. The sediment is rinsed and dried, and thereby a dried product is formed.

### <(B) Calcination>

The dried product thus obtained is mixed with a lithium compound to form a mixture. For example, the lithium compound may include Li₂CO₃, LiOH, and/or the like. The mixture is subjected to heat treatment (calcination). The calcination temperature may be from 500 to 1000° C., for example. The calcination duration may be from 5 to 30 hours, for example. In this manner, a positive electrode active material particle is produced.

### <<Lithium-Ion Battery>>

FIG. 2 is a conceptual view illustrating an example of a lithium-ion battery according to the present embodiment. A battery 100 includes a power generation element 50 and an electrolyte (not illustrated).

### <Exterior Package>

Battery 100 may include an exterior package (not illustrated). The exterior package may accommodate power generation element 50 and the electrolyte. The exterior package may have any configuration. The exterior package may be a case made of metal, or may be a pouch made of a metal foil laminated film, for example. The case may be in any shape. The case may be cylindrical, prismatic, flat, coin-shaped, and/or the like, for example. The exterior package may include Al and/or the like, for example. The exterior package may accommodate a single power generation element 50, or may accommodate a plurality of power generation elements 50, for example. The plurality of power generation elements 50 may form a series circuit, or may form a parallel circuit, for example. Inside the exterior package, the plurality of power generation elements 50 may be stacked in the thickness direction of battery 100.

### <Power Generation Element>

Power generation element 50 may also be called “an electrode group”, “an electrode assembly”, and the like. Power generation element 50 includes a positive electrode 10 and a negative electrode 20. Power generation element 50 may further include a separator 30. Separator 30 is interposed between positive electrode 10 and negative electrode 20. Power generation element 50 may have any configuration. For example, power generation element 50 may be a stack-type one. For example, positive electrode 10 and negative electrode 20 may be alternately stacked with separator 30 interposed between positive electrode 10 and negative electrode 20 to form power generation element 50. For example, power generation element 50 may be a wound-type one. For example, positive electrode 10 having a belt-like shape, separator 30 having a belt-like shape, and negative electrode 20 having a belt-like shape may be stacked to form a stack. The resulting stack may be wound spirally to form power generation element 50. After being wound, the wound power generation element 50 may be shaped into a flat form.

### <Positive Electrode>

Positive electrode 10 may be in sheet form, for example. Positive electrode 10 includes a positive electrode current collector 11 and a positive electrode active material layer 12. Positive electrode current collector 11 is electrically conductive. Positive electrode current collector 11 supports positive electrode active material layer 12. Positive electrode current collector 11 may be in sheet form, for example. Positive electrode current collector 11 may have a thickness from 5 to 50 μm, for example. Positive electrode current collector 11 may include a metal foil, for example. Positive electrode current collector 11 may include at least one selected from the group consisting of Al, Mn, Ti, Fe, and Cr, for example. Positive electrode current collector 11 may include an Al foil, an Al alloy foil, a Ti foil, a stainless steel (SUS) foil, and/or the like, for example.

Between positive electrode current collector 11 and positive electrode active material layer 12, an intermediate layer (not illustrated) may be formed. The intermediate layer does not include a positive electrode active material particle. The intermediate layer may have a thickness from 0.1 to 5 μm, for example. The intermediate layer may include a conductive material, an insulation material, a binder, and/or the like, for example. The conductive material and the binder are described below. The insulation material may include alumina, boehmite, aluminum hydroxide, and/or the like, for example.

Positive electrode active material layer 12 is placed on the surface of positive electrode current collector 11. Positive electrode active material layer 12 may be placed on only one side of positive electrode current collector 11. Positive electrode active material layer 12 may be placed on both sides of positive electrode current collector 11. Positive electrode active material layer 12 may have a thickness of 10 μm or more, or may have a thickness of 50 μm or more, or may have a thickness of 80 μm or more, or may have a thickness of 100 μm or more, for example. It is conceivable that when positive electrode active material layer 12 is thick, more specifically when the thickness thereof is 80 μm or more, post-endurance retention is enhanced even more. Positive electrode active material layer 12 may have a thickness of 1000 μm or less, or may have a thickness of 500 μm or less, or may have a thickness of 300 μm or less. Positive electrode active material layer 12 includes a positive electrode active material particle. Positive electrode active material layer 12 may further include a conductive material, a binder, carbon nanotubes, and the like, for example.

### <<Conductive Material>>

The conductive material may form an electron conduction path inside positive electrode active material layer 12. The amount of the conductive material to be used may be, for example, from 0.1 to 10 parts by mass relative to 100 parts by mass of the positive electrode active material particle. The conductive material may include any component. The conductive material may include, for example, at least one selected from the group consisting of graphite, acetylene black (AB), Ketjenblack (registered trademark), vapor grown carbon fibers (VGCFs), carbon nanotubes (CNTs), and graphene flakes (GFs).

### <<Binder>>

The binder is capable of fixing positive electrode active material layer 12 to positive electrode current collector 11. The amount of the binder to be used may be, for example, from 0.1 to 10 parts by mass relative to 100 parts by mass of the positive electrode active material particle. The binder may include any component. The binder may include, for example, at least one selected from the group consisting of polyvinylidene difluoride (PVdF), vinylidene difluoride-hexafluoropropylene copolymer (PVdF-HFP), tetrafluoroethylene (PTFE), CMC, PAA, polyvinyl alcohol (PVA), polyvinylpyrrolidone (PVP), polyoxyethylene alkyl ether, and derivatives of these.

### <<Carbon Nanotubes>>

Carbon nanotubes (CNTs) have a high electronic conductivity. Hence, when positive electrode active material layer 12 includes CNTs, electronic conductivity is ensured and, as a result, initial resistance and capacity retention are expected to be improved. In some embodiments, CNTs are included in the internal portion of the positive electrode active material particle. When CNTs are included in the internal portion of the positive electrode active material particle, the CNTs are expected to form composites, which can ensure electronic conductivity more reliably.

The CNTs may have an aspect ratio of 20 or more, for example. When the CNTs have an aspect ratio of 20 or more, the CNTs tend to be included in internal portion 1 of positive electrode active material particle 5, and thereby resistance is expected to be reduced. The CNTs may have an aspect ratio of 100 or more.

The aspect ratio is the ratio of length to diameter. Herein, “aspect ratio” is determined by dividing the average length of the CNTs by the average diameter of the CNTs. Each of the average length and the average diameter may be the arithmetic mean of values that are measured for ten or more CNTs. The length and the diameter of individual CNTs are measured with a TEM or a scanning electron microscope (SEM).

The CNTs may have an average diameter from 10 nm to 50 nm, for example. The CNTs may have an average length from 1 μm to 5 μm, for example.

The content rate of the CNTs in positive electrode active material layer 12 may be from 0.1 mass % to 5.0 mass %, for example. When the content rate of the CNTs in positive electrode active material layer 12 satisfies the above-mentioned range, initial resistance and capacity retention are expected to be improved. In some embodiments, the content rate of the CNTs in positive electrode active material layer 12 is from 0.5 mass % to 4.0 mass %.

### <<Other Components>>

Positive electrode active material layer 12 may further include an inorganic filler, an organic filler, a solid electrolyte, a surface modifier, a lubricant, a flame retardant, a protective agent, a flux, a coupling agent, an adsorbent, and/or the like, for example. Positive electrode active material layer 12 may include polyoxyethylene allylphenyl ether phosphate, zeolite, silane coupling agent, MoS₂, WO₃, and/or the like, for example.

### <Negative Electrode>

Negative electrode 20 may be in sheet form, for example. Negative electrode 20 may include a negative electrode current collector 21 and a negative electrode active material layer 22, for example. Negative electrode current collector 21 is electrically conductive. Negative electrode current collector 21 supports negative electrode active material layer 22. Negative electrode current collector 21 may be in sheet form, for example. Negative electrode current collector 21 may have a thickness from 5 to 50 μm, for example. Negative electrode current collector 21 may include a metal foil and/or the like, for example. Negative electrode current collector 21 may include at least one selected from the group consisting of Cu, Ni, Fe, Zn, Pb, Ag, and Au, for example. Negative electrode current collector 21 may include a Cu foil, a Cu alloy foil, and/or the like, for example.

Negative electrode active material layer 22 is placed on the surface of negative electrode current collector 21. Negative electrode active material layer 22 may be placed on only one side of negative electrode current collector 21. Negative electrode active material layer 22 may be placed on both sides of negative electrode current collector 21. Negative electrode active material layer 22 may have a thickness from 10 to 1000 μm, or from 50 to 500 μm, or from 100 to 300 μm, for example. Negative electrode active material layer 22 includes a negative electrode active material. The negative electrode active material layer may further include a conductive material, a binder, and the like, for example.

Negative electrode active material layer 22 may have a thickness from 10 to 1000 μm, or from 50 to 500 μm, or from 100 to 300 μm, for example. Negative electrode active material layer 22 includes a negative electrode active material. The negative electrode active material layer may further include a conductive material, a binder, and the like, for example.

### <<Conductive Material>>

The conductive material may form an electron conduction path inside negative electrode active material layer 22. The content of the conductive material may be, for example, from 0.1 to 10 parts by mass relative to 100 parts by mass of the negative electrode active material. The conductive material may include any component. The conductive material may include at least one selected from the group consisting of graphite, AB, Ketjenblack, VGCFs, CNTs, and GFs, for example. The CNTs may include at least one selected from the group consisting of single-walled CNTs (SWCNTs) and multi-walled CNTs (MWCNTs).

### <<Binder>>

The binder is capable of fixing negative electrode active material layer 22 to negative electrode current collector 21. The content of the binder may be, for example, from 0.1 to 10 parts by mass relative to 100 parts by mass of the negative electrode active material. The binder may include any component. The binder may include, for example, at least one selected from the group consisting of styrene-butadiene rubber (SBR), acrylate butadiene rubber (ABR), sodium alginate, carboxymethylcellulose (such as CMC-H, CMC-Na, CMC-Li, CMC-NH₄), polyacrylic acid (such as PAA-H, PAA-Na, PAA-Li), polyacrylonitrile (PAN), polyvinylidene difluoride (PVdF), polytetrafluoroethylene (PTFE), acrylic resin (acrylic acid ester copolymer), methacrylic resin (methacrylic acid ester copolymer), polyvinylpyrrolidone (PVP), polyvinyl alcohol (PVA), and derivatives of these. For example, the expression “CMC-Na” refers to a Na salt of CMC. For example, the expression “CMC-H” refers to an acid-type CMC. The same applies to “PAA-Na” and the like.

### <<Other Components>>

Negative electrode active material layer 22 may further include an inorganic filler, an organic filler, a solid electrolyte, a surface modifier, a dispersant, a lubricant, a flame retardant, a protective agent, a flux, a coupling agent, an adsorbent, and/or the like, for example. The negative electrode active material layer may include a layered silicate (such as smectite, montmorillonite, bentonite, hectorite), an inorganic filler (such as solid alumina, hollow silica, boehmite), a polysiloxane compound, and/or the like, for example.

### <<Negative Electrode Active Material>>

The negative electrode active material may include, for example, at least one selected from the group consisting of natural graphite, artificial graphite, soft carbon, hard carbon, silicon (Si), SiO, Li silicate, Si-based alloy, tin (Sn), SnO, Sn-based alloy, and Li₄Ti₅O₁₂.

### <Carbon-Based Active Material>

The “graphite” collectively refers to natural graphite and artificial graphite. The graphite may be a mixture of natural graphite and artificial graphite. The mixing ratio (mass ratio) may be “(natural graphite)/(artificial graphite)=1/9 to 9/1”, or “(natural graphite)/(artificial graphite)=2/8 to 8/2”, or “(natural graphite)/(artificial graphite)=3/7 to 7/3”, for example.

The graphite may include a dopant. The dopant may include, for example, at least one selected from the group consisting of B, N, P, Li, and Ca. The amount to be added may be from 0.01 to 5%, or from 0.1 to 3%, or from 0.1 to 1% in molar fraction, for example.

The surface of the graphite may be covered with amorphous carbon, for example. The surface of the graphite may be covered with another type of material, for example. This another type of material may include, for example, at least one selected from the group consisting of P, W, Al, and O. The another type of material may include, for example, at least one selected from the group consisting of Al(OH)₃, AlOOH, Al₂O₃, WO₃, Li₂CO₃, LiHCO₃, and Li₃PO₄.

### <Alloy-Based Active Material>

SiO may be represented by the following formula (B-1), for example.

SiOₓ (B-1)

In the above formula, the relationship of 0<x<2 is satisfied.

In the above formula (B-1), x may satisfy 0.5≤x≤1.5 or 0.8≤x≤1.2, for example.

Li silicate may include, for example, at least one selected from the group consisting of Li₄SiO₄, Li₂SiO₃, Li₂Si₂O₅, and Li₈SiO₆. A second negative electrode active material may include a mixture of Si and Li silicate, for example. The mixing ratio (mass ratio) may be “Si/(Li silicate)=1/9 to 9/1”, or “Si/(Li silicate)=2/8 to 8/2”, or “Si/(Li silicate)=3/7 to 7/3”, or “Si/(Li silicate)=4/6 to 6/4”, for example.

The alloy-based active material (such as Si, SiO) may include an additive. The additive may be a substituted solid solution atom or an intruding solid solution atom, for example. The additive may be an adherent adhered to the surface of the alloy-based active material. The adherent may be an elementary substance, an oxide, a carbide, a nitride, a halide, and/or the like, for example. The amount to be added may be from 0.01 to 5%, or from 0.1 to 3%, or from 0.1 to 1% in molar fraction, for example. The additive may include, for example, at least one selected from the group consisting of Li, Na, K, Rb, Be, Mg, Ca, Sr, Fe, Ba, B, Al, Ga, In, C, Ge, Sn, Pb, N, P, As, Y, Sb, and S. That is, SiO may be doped with Mg and/or Na. For example, Mg silicate and/or Na silicate may be formed. For example, boron oxide (such as B₂O₃, for example), yttrium oxide (such as Y₂O₃, for example), and/or the like may be added to SiO.

### <Si-C Composite Material>

The negative electrode active material may include a composite material of the carbon-based active material (such as graphite) and the alloy-based active material (such as Si), for example. A composite material including Si and carbon may also be called “an Si—C composite material”. For example, Si microparticles may be dispersed inside carbon particles. For example, Si microparticles may be dispersed inside graphite particles. For example, Li silicate particles may be covered with a carbon material (such as amorphous carbon). The Si—C composite material and graphite may be mixed together for use.

### <Multi-Component System>

The negative electrode active material may include two or more components. The negative electrode active material may include the carbon-based active material (such as graphite) and the alloy-based active material (such as Si, SiO). The mixing ratio (mass ratio) of the carbon-based active material and the alloy-based active material may be “(carbon-based active material)/(alloy-based active material)=1/9 to 9/1”, or “(carbon-based active material)/(alloy-based active material)=2/8 to 8/2”, or “(carbon-based active material)/(alloy-based active material)=3/7 to 7/3”, or “(carbon-based active material)/(alloy-based active material)=4/6 to 6/4”, for example.

### <Separator>

Separator 30 is capable of separating positive electrode 10 from negative electrode 20. Separator 30 is electrically insulating. Separator 30 may include, for example, at least one selected from the group consisting of a resin film, an inorganic particle layer, and an organic particle layer. Separator 30 may include a resin film and an inorganic particle layer, for example.

### <<Resin Film>>

The resin film is porous. The resin film may include a microporous film, a nonwoven fabric, and/or the like, for example. The resin film includes a resin skeleton. The resin skeleton may be contiguous in mesh form, for example. Gaps in the resin skeleton form pores. The resin film allows the electrolyte to permeate therethrough. The resin film may have an average pore size of 1 μm or less, for example. The resin film may have an average pore size from 0.01 to 1 μm, or from 0.1 to 0.5 μm, for example. The “average pore size” may be measured by mercury porosimetry. The resin film may have a Gurley value from 50 to 250 s/100 cm³, for example. “Gurley value” may be measured by a Gurley test method.

The resin film may include, for example, at least one selected from the group consisting of an olefin-based resin, a polyurethane-based resin, a polyamide-based resin, a cellulose-based resin, a polyether-based resin, an acrylic-based resin, a polyester-based resin, and the like. The resin film may include, for example, at least one selected from the group consisting of polyethylene (PE), polypropylene (PP), polyamide (PA), polyamide-imide (PAI), polyimide (PI), aromatic polyamide (aramid), and polyphenylene ether (PPE), and derivatives of these. The resin film may be formed by stretching, phase separation, and/or the like, for example. The resin film may have a thickness from 5 to 50 μm, or from 10 to 25 μm, for example.

The resin film may have a monolayer structure. The resin film may consist of a PE layer, for example. A skeleton of a PE layer is formed of PE. The PE layer may have shut-down function. The resin film may have a multilayer structure, for example. The resin film may include a PP layer and a PE layer, for example. A skeleton of a PP layer is formed of PP. The resin film may have a three-layer structure, for example. The resin film may be formed by stacking a PP layer, a PE layer, and a PP layer in this order, for example. The thickness of the PE layer may be from 5 to 20 μm, for example. The thickness of the PP layer may be from 3 to 10 μm, for example.

### <<Inorganic Particle Layer>>

The inorganic particle layer may be formed on the surface of the resin film. The inorganic particle layer may be formed on only one side of the resin film, or may be formed on both sides of the resin film. The inorganic particle layer may be formed on the side facing positive electrode 10, or may be formed on the side facing negative electrode 20. The inorganic particle layer may be formed on the surface of positive electrode 10, or may be formed on the surface of negative electrode 20.

The inorganic particle layer is porous. The inorganic particle layer includes inorganic particles. The inorganic particles may also be called “an inorganic filler”. Gaps between the inorganic particles form pores. The inorganic particle layer may have a thickness from 0.5 to 10 μm, or from 1 to 5 μm, for example. The inorganic particles may include a heat-resistant material, for example. The inorganic particle layer that includes a heat-resistant material is also called “HRL (Heat Resistance Layer)”. The inorganic particles may include at least one selected from the group consisting of boehmite, alumina, zirconia, titania, magnesia, silica, and the like. The inorganic particles may be in any shape. The inorganic particles may be spherical, rod-like, plate-like, fibrous, and/or the like, for example. The inorganic particles may have a D50 from 0.1 to 10 μm, or from 0.5 to 3 μm, for example. The inorganic particle layer may further include a binder. The binder may include, for example, at least one selected from the group consisting of an acrylic-based resin, a polyamide-based resin, a fluorine-based resin, an aromatic-polyether-based resin, and a liquid-crystal-polyester-based resin, and the like.

### <<Organic Particle Layer>>

Separator 30 may include an organic particle layer, for example. Separator 30 may include an organic particle layer instead of the resin film, for example. Separator 30 may include an organic particle layer instead of the inorganic particle layer, for example. Separator 30 may include both the resin film and an organic particle layer. Separator 30 may include both the inorganic particle layer and an organic particle layer. Separator 30 may include the resin film, the inorganic particle layer, and an organic particle layer.

The organic particle layer may have a thickness from 0.1 to 50 μm, or from 0.5 to 20 μm, or from 0.5 to 10 μm, or from 1 to 5 μm, for example. The organic particle layer includes organic particles. The organic particles may also be called “an organic filler”. The organic particles may include a heat-resistant material. The organic particles may include, for example, at least one selected from the group consisting of PE, PP, PTFE, PI, PAI, PA, aramid, and the like. The organic particles may be spherical, rod-like, plate-like, fibrous, and/or the like, for example. The organic particles may have a D50 from 0.1 to 10 μm, or from 0.5 to 3 μm, for example.

Separator 30 may include a mixed layer, for example. The mixed layer includes both inorganic particles and organic particles.

### <Electrolyte>

The electrolyte dissolves Li ions in it. The electrolyte may be a liquid electrolyte, or may be a gelled electrolyte. The liquid electrolyte may include an electrolyte solution, for example. The electrolyte solution includes a solvent and a solute.

### <<Solvent>>

### <Ether-Based Solvent>

The electrolyte solution may include an ether-based solvent and/or the like, for example. The solvent may include hydrofluoroether (HFE) and/or the like, for example. HFE may include, for example, at least one selected from the group consisting of a difluoromethyl group, a 2,2-difluoroethyl group, a 2,2,2-trifluoroethyl group, a 1,1,2,2-tetrafluoroethyl group, a 2,2,3,3,3-pentafluoropropyl group, a 2,2,3,3-tetrafluoropropyl group, a 1,1,1,3,3,3-hexafluoroisopropyl group, a 1,1,2,3,3,3-hexafluoropropyl group, a 2,2,3,3,4,4,4-heptafluorobutyl group, a 2,2,3,3,4,4-hexafluorobutyl group, and a 2,2,3,3,4,4,5,5-octafluoropentyl group.

The solvent may also include an ether other than HFE (the ether may also be called “a second ether” hereinafter). The second ether may include, for example, at least one selected from the group consisting of tetrahydrofuran (THF), 1,4-dioxane (DOX), 1,3-dioxolane (DOL), 1,2-dimethoxyethane (DME), 1,2-diethoxyethane (DEE), ethylglyme, triglyme, tetraglyme, and derivatives of these. For example, the solvent may include the second ether (such as DME) in a volume fraction from 1 to 50%, with the remainder being made up of HFE. For example, the solvent may include the second ether in a volume fraction from 10 to 40%, with the remainder being made up of HFE.

### <Carbonate-Based Solvent>

The electrolyte solution may include a carbonate-based solvent (a carbonate-ester-based solvent), for example. The solvent may include a cyclic carbonate, a chain carbonate, a fluorinated carbonate, and/or the like, for example. The solvent may include, for example, at least one selected from the group consisting of ethylene carbonate (EC), propylene carbonate (PC), butylene carbonate (BC), dimethyl carbonate (DMC), diethyl carbonate (DEC), ethyl methyl carbonate (EMC), monofluoroethylene carbonate (FEC), difluoroethylene carbonate, 4,4-difluoroethylene carbonate, trifluoroethylene carbonate, perfluoroethylene carbonate, fluoropropylene carbonate, difluoropropylene carbonate, and derivatives of these.

The solvent may include a cyclic carbonate (such as EC, PC, FEC) and a chain carbonate (such as EMC, DMC, DEC). The mixing ratio between the cyclic carbonate and the chain carbonate (volume ratio) may be “(cyclic carbonate)/(chain carbonate)=1/9 to 4/6”, or “(cyclic carbonate)/(chain carbonate)=2/8 to 3/7”, or “(cyclic carbonate)/(chain carbonate)=3/7 to 4/6”, for example.

The solvent may include a cyclic carbonate (such as EC, PC) and a fluorinated cyclic carbonate (such as FEC). The mixing ratio between the cyclic carbonate and the fluorinated cyclic carbonate (volume ratio) may be “(cyclic carbonate)/(fluorinated cyclic carbonate)=99/1 to 90/10”, or “(cyclic carbonate)/(fluorinated cyclic carbonate)=9/1 to 1/9”, or “(cyclic carbonate)/(fluorinated cyclic carbonate)=9/1 to 7/3”, or “(cyclic carbonate)/(fluorinated cyclic carbonate)=3/7 to 1/9”, for example.

The solvent may include EC, FEC, EMC, DMC, and DEC, for example. The volume ratio of these components may satisfy the relationship represented by the following equation (C-1), for example.

$${V}_{EC} + {V}_{FEC} + {V}_{EMC} + {V}_{DMC} + {V}_{DEC} = 10 \qquad ( C - 1 )$$

In the above equation, each of V_{EC}, V_{FEC}, V_{EMC}, V_{DMC}, and V_{DEC} represents the volume ratio of EC, FEC, EMC, DMC, and DEC, respectively.

The following relationships are satisfied: 1≤V_{EC}≤4, 0≤V_{FEC}≤3, V_{EC}+V_{FEC}≤4, 0≤V_{EMC}≤9, 0≤V_{DMC}≤9, 0≤V_{DEC}≤9, 6≤V_{EMC}+V_{DMC}+V_{DEC}≤9.

In the above equation (C-1),
the relationship of 1≤V_{EC}≤2 or 2≤V_{EC}≤3 may be satisfied, for example.

The relationship of 1≤V_{FEC}≤2 or 2≤V_{FEC}≤4 may be satisfied, for example.

The relationship of 3≤V_{EMC}≤4 or 6≤V_{EMC}≤8 may be satisfied, for example.

The relationship of 3≤V_{DMC}≤4 or 6≤V_{DMC}≤8 may be satisfied, for example.

The relationship of 3≤V_{DEC}≤4 or 6≤V_{DEC}≤8 may be satisfied, for example.

The solvent may have a composition of “EC/EMC=3/7”, “EC/DMC=3/7”, “EC/FEC/DEC=1/2/7”, “EC/DMC/EMC=3/4/3”, “EC/DMC/EMC=3/3/4”, “EC/FEC/DMC/EMC=2/1/4/3”, “EC/FEC/DMC/EMC=1/2/4/3”, “EC/FEC/DMC/EMC=2/1/3/4”, “EC/FEC/DMC/EMC=1/2/3/4” (volume ratio), and/or the like, for example.

### <Additive>

The electrolyte solution may include any additive. The amount to be added (the mass fraction to the total amount of the electrolyte solution) may be from 0.01 to 5%, or from 0.05 to 3%, or from 0.1 to 1%, for example. The additive may include an SEI (Solid Electrolyte Interphase) formation promoter, an SEI formation inhibitor, a gas generation agent, an overcharging inhibitor, a flame retardant, an antioxidant, an electrode-protecting agent, a surfactant, and/or the like, for example.

The additive may include, for example, at least one selected from the group consisting of vinylene carbonate (VC), vinylethylene carbonate (V_{EC}), 1,3-propane sultone (PS), tert-amylbenzene, 1,4-di-tert-butylbenzene, biphenyl (BP), cyclohexylbenzene (CHB), ethylene sulfite (ES), propane sultone (PS), ethylene sulfate (DTD), γ-butyrolactone, phosphazene compound, carboxylate ester [such as methyl formate (MF), methyl acetate (MA), methyl propionate (MP), diethyl malonate (DEM), for example], fluorobenzene (such as monofluorobenzene (FB), 1,2-difluorobenzene, 1,3-difluorobenzene, 1,4-difluorobenzene, 1,2,3-trifluorobenzene, 1,2,4-trifluorobenzene, 1,3,5-trifluorobenzene, 1,2,3,4-tetrafluorobenzene, 1,2,3,5-tetrafluorobenzene, 1,2,4,5-tetrafluorobenzene, pentafluorobenzene, hexafluorobenzene, for example), fluorotoluene (such as 2-fluorotoluene, 3-fluorotoluene, 4-fluorotoluene, 2,3-difluorotoluene, 2,4-difluorotoluene, 2,5-difluorotoluene, 2,6-difluorotoluene, 3,4-difluorotoluene, octafluorotoluene, for example), benzotrifluoride (such as benzotrifluoride, 2-fluorobenzotrifluoride, 3-fluorobenzotrifluoride, 4-fluorobenzotrifluoride, 2-methylbenzotrifluoride, 3-methylbenzotrifluoride, 4-methylbenzotrifluoride, for example), fluoroxylene (such as 3-fluoro-o-xylene, 4-fluoro-o-xylene, 2-fluoro-m-xylene, 5-fluoro-m-xylene, for example), sulfur-containing heterocyclic compound (such as benzothiazole, 2-methylbenzothiazole, tetrathiafulvalene, for example), nitrile compound (such as adiponitrile, succinonitrile, for example), phosphate (such as trimethyl phosphate, triethyl phosphate, for example), carboxylic anhydride (such as acetic anhydride, propionic anhydride, oxalic anhydride, succinic anhydride, maleic anhydride, phthalic anhydride, benzoic anhydride, for example), alcohol (such as methanol, ethanol, n-propyl alcohol, ethylene glycol, diethylene glycol monomethyl ether, for example), and derivatives of these.

The components described above as the solute and the solvent may be used as a trace component (an additive). The additive may include, for example, at least one selected from the group consisting of LiBF₄, LiFSI, LiTFSI, LiBOB, LIDFOB, LiDFOP, LiPO₂F₂, FSO₃Li, LiI, LiBr, HFE, DOX, PC, FEC, and derivatives of these.

### <<Ionic Liquid>>

The liquid electrolyte may include an ionic liquid. The liquid electrolyte may include, for example, at least one selected from the group consisting of a sulfonium salt, an ammonium salt, a pyridinium salt, a piperidinium salt, a pyrrolidinium salt, a morpholinium salt, a phosphonium salt, an imidazolium salt, and derivatives of these.

### <<Gelled Electrolyte>>

The gelled electrolyte may include a liquid electrolyte and a polymer material. The polymer material may form a polymer matrix. The polymer material may include, for example, at least one selected from the group consisting of PVdF, PVdF-HFP, PAN, PVdF-PAN, polyethylene oxide (PEO), polyethylene glycol (PEG), and derivatives of these.

### <Battery Configuration>

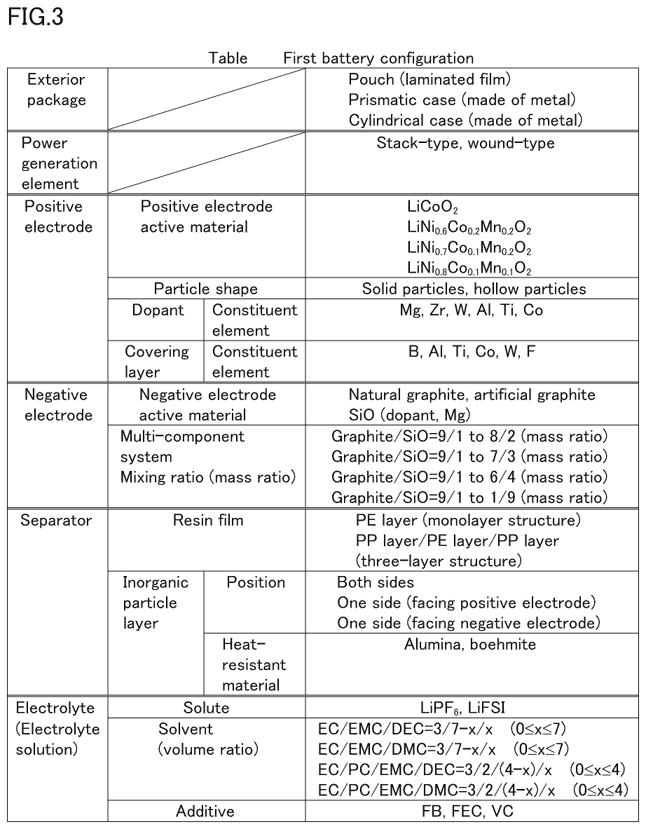

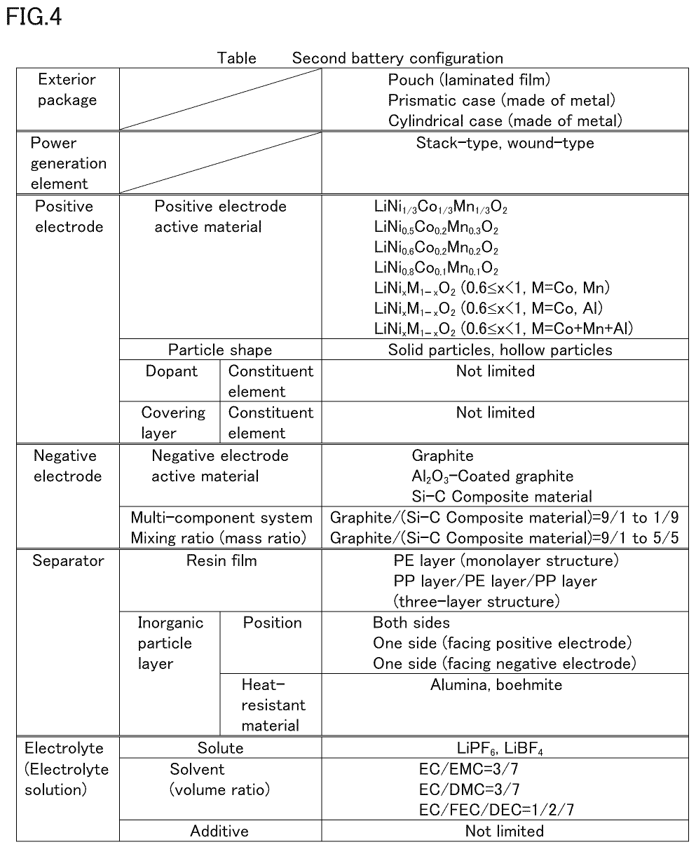

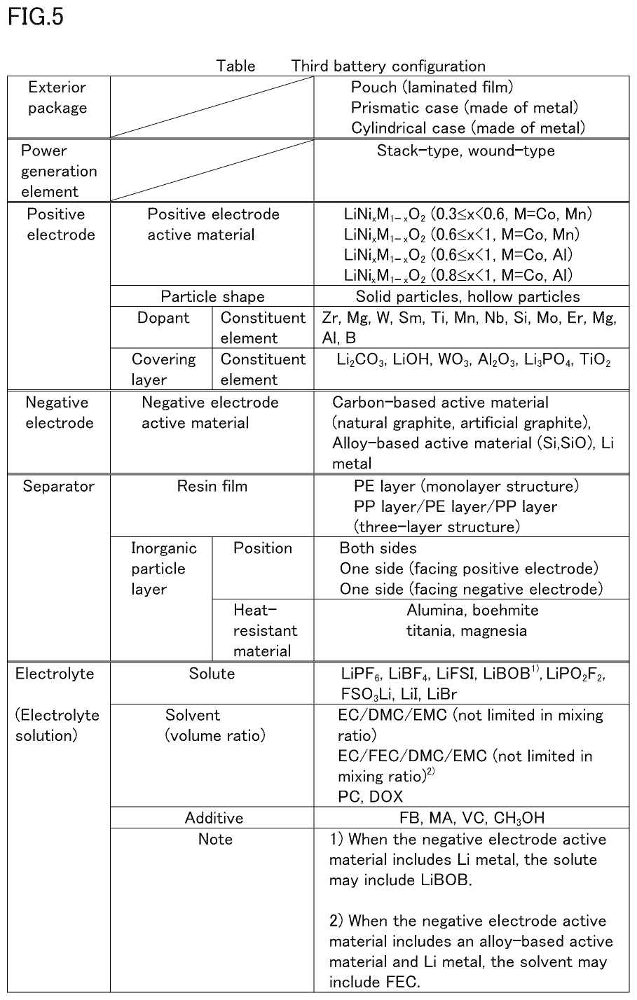

FIG. 3 is a table showing a first battery configuration. FIG. 4 is a table showing a second battery configuration. FIG. 5 is a table showing a third battery configuration. In each table, when a plurality of materials are described in a single cell, this description is intended to mean one of them as well as a combination of them. For example, when materials “α, β, γ” are described in a single cell, this description is intended to mean “at least one selected from the group consisting of α, β, and γ”. Certain elements may be extracted from the first to third battery configurations and optionally combined together.

The present embodiment may be incorporated into the first to third battery configurations, for example. The positive electrode in the first battery configuration may be replaced by the positive electrode (positive electrode current collector 11, positive electrode active material layer 12) according to the present embodiment. For example, combining the first to third battery configurations with the present embodiment may improve battery performance.

### EXAMPLES

In the following, the present embodiment will be described using Examples, but the present embodiment is not limited to these Examples. Hereinafter, the method of producing a positive electrode active material particle of Nos. 2 to 4 may be called “a doping method”, the method of producing a positive electrode active material particle of Nos. 5 to 7 may be called “an MHP method”, and the method of producing a positive electrode active material particle of Nos. 8 to 10 may be called “a late-addition method”.

### <Production of Positive Electrode Active Material Particle>

### (No. 1)

An aqueous nickel sulfate solution (1.8 mol/L) (hereinafter, “mol/L” may also be simply expressed as “M”) was prepared. To the aqueous nickel sulfate solution, an aqueous NaOH solution (1.0 M) was added dropwise, and thereby a sediment was formed. The dropwise addition of the aqueous NaOH solution was regulated so that the pH was maintained at 11.6. The sediment was rinsed and dried, and thereby a dried product was formed. The dried product was mixed with LiOH, and thereby a mixture was formed. The mixture thus formed had a mixing ratio of Li and Ni (Li/Ni) (molar ratio) of 1.04. The mixture was calcined. The calcination temperature was 880° C. The calcination duration was 6 hours. In this manner, a positive electrode active material particle of No. 1 having a lamellar rock salt structure was synthesized. It was also checked that the positive electrode active material particles of Nos. 2 to 10 described below had a lamellar rock salt structure as well.

### (No. 2)

Nickel sulfate and magnesium sulfate were dissolved in water, and thereby an aqueous acidic solution (1.8 M) was prepared. The blending ratio of the solutes (molar ratio) was (nickel sulfate):(magnesium sulfate)=96.8:3.2. To the aqueous acidic solution, an aqueous NaOH solution (1.0 M) was added dropwise, and thereby a sediment was formed. The dropwise addition of the aqueous NaOH solution was regulated so that the pH was maintained at 11.6. The sediment was rinsed and dried, and thereby a dried product was formed. The dried product was mixed with LiOH, and thereby a mixture was formed. The mixture thus formed had a mixing ratio of Li to Ni and Mg (Li/(Ni+Mg)) (molar ratio) of 1.04. The calcination temperature was 880° C. The calcination duration was 6 hours. In this manner, a positive electrode active material particle of No. 2 was synthesized.

### (Nos. 3 to 4)

Positive electrode active material particles of Nos. 3 and 4 were synthesized under the same conditions as those for No. 2 except that the blending ratio of the solutes of the aqueous acidic solution was changed to (nickel sulfate):(magnesium sulfate)=94.4:5.6 for No. 3 and the blending ratio of the solutes of the aqueous acidic solution was changed to (nickel sulfate):(magnesium sulfate)=98.7:1.3 for No. 4.

### (No. 5)

A mixed hydroxide of nickel hydroxide and magnesium hydroxide was prepared. The blending ratio (molar ratio) was (nickel hydroxide):(magnesium hydroxide)=96.7:3.1. Powder of the mixed hydroxide was pulverized in a mortar until the D50 reached about 3 μm. The pulverized powder of the mixed hydroxide was dissolved in an aqueous ammonia solution (mass concentration, 10%), and thereby a mixed solution was prepared. To the resulting mixed solution, an aqueous nickel sulfate solution (1.8 M) and an aqueous NaOH solution (1.0M) were added dropwise at the same time, and thereby a sediment was formed. The dropwise addition of the aqueous nickel sulfate solution and the aqueous NaOH solution was regulated so that the pH was maintained at 11.6. The sediment was rinsed and dried, and thereby a dried product was formed. The dried product was mixed with LiOH, and thereby a mixture was formed. The mixture thus formed had a mixing ratio of Li to Ni and Mg (Li/(Ni+Mg)) (molar ratio) of 1.04. The calcination temperature was 880° C. The calcination duration was 6 hours. In this manner, a positive electrode active material particle of No. 5 was synthesized.

### (Nos. 6 to 7)

Positive electrode active material particles of Nos. 6 and 7 were synthesized under the same conditions as those for No. 5 except that the blending ratio in the mixed hydroxide for No. 6 was (nickel hydroxide):(magnesium hydroxide)=94.2:5.8 and the blending ratio of the solutes in the mixed hydroxide for No. 7 was (nickel hydroxide):(magnesium hydroxide)=99.1:0.9.

### (No. 8)

The positive electrode active material particle of No. 1 was prepared. The positive electrode active material particle was mixed with magnesium oxide, and thereby a mixture was formed. The mixture thus formed had a mixing ratio of Ni and Mg (Ni:Mg) (molar ratio) of 96.9:3.1. The mixture was calcined. The calcination temperature was 500° C. The calcination duration was 5 hours. In this manner, a positive electrode active material particle of No. 8 was synthesized.

### (Nos. 9 to 10)

Positive electrode active material particles of Nos. 9 and 10 were synthesized under the same conditions as those for No. 8 except that the mixing ratio of Ni and Mg for No. 9 was 94.6:5.4 and the mixing ratio of Ni and Mg for No. 10 was 98.9:1.1.

### <Production of Lithium-Ion Battery>

### Example 1

The materials described below were used to produce a positive electrode of

### Example 1

### <<Positive Electrode>>

Positive electrode active material particle: No. 2 Conductive material: AB (Denka Company Limited) Binder: PVDF (Kureha Corporation) Moreover, the materials described below were used to produce an evaluation-purpose test battery of Example 1.

<<Negative Electrode>>

Negative electrode active material: Natural graphite (Hitachi Chemical Company, Ltd.)

Binder: CMC (Nippon Paper Industries Co., Ltd.), SBR (JSR Corporation)

### <<Others>>

Separator: Porous sheet (thickness, 24 μm)

Electrolyte: Electrolyte solution [LiPF₆ (1 M), EC+DMC+EMC]

### Example 2

A positive electrode and an evaluation-purpose test battery of Example 2 were produced under the same conditions as those in Example 1 except that the positive electrode active material particle of Example 2 was No. 3.

### Examples 3 to 5

Positive electrodes and evaluation-purpose test batteries of Examples 3 to 5 were produced under the same conditions as those in Example 1 except that 0.4 mass % CNTs were added to the positive electrode of Example 1, 1.0 mass % CNTs were added to the positive electrode of Example 1, and 4.0 mass % CNTs were added to the positive electrode of Example 1, respectively.

### Examples 6 to 8

Positive electrodes and evaluation-purpose test batteries of Examples 6 to 8 were produced under the same conditions as those in Example 1 except that the positive electrode active material particle of Example 6 was No. 5, the positive electrode active material particle of Example 7 was No. 6, and the positive electrode active material particle of Example 8 was No. 7.

### Examples 9 to 11

Positive electrodes and evaluation-purpose test batteries of Examples 9 to 11 were produced under the same conditions as those in Example 1 except that 0.4 mass % CNTs were added to the positive electrode of Example 6, 1.0 mass % CNTs were added to the positive electrode of Example 6, and 4.0 mass % CNTs were added to the positive electrode of Example 6, respectively.

### Comparative Example 1

A positive electrode and an evaluation-purpose test battery of Comparative Example 1 were produced under the same conditions as those in Example 1 except that the positive electrode active material particle of Comparative Example 1 was No. 1.

### Comparative Example 2

A positive electrode and an evaluation-purpose test battery of Comparative Example 2 were produced under the same conditions as those in Example 1 except that the positive electrode active material particle of Comparative Example 2 was No. 4.

### Comparative Examples 3 to 5

Positive electrodes and evaluation-purpose test batteries of Comparative Examples 3 to 5 were produced under the same conditions as those in Example 1 except that the positive electrode active material particle of Comparative Example 3 was No. 8, the positive electrode active material particle of Comparative Example 4 was No. 9, and the positive electrode active material particle of Comparative Example 5 was No. 10.

### Comparative Examples 6 to 8

Positive electrodes and evaluation-purpose test batteries of Comparative Examples 6 to 8 were produced under the same conditions as those in Example 1 except that 0.4 mass % CNTs were added to the positive electrode of Comparative Example 3, 1.0 mass % CNTs were added to the positive electrode of Comparative Example 3, and 4.0 mass % CNTs were added to the positive electrode of Comparative Example 3, respectively.

### <Analysis>

### <<Composition>>

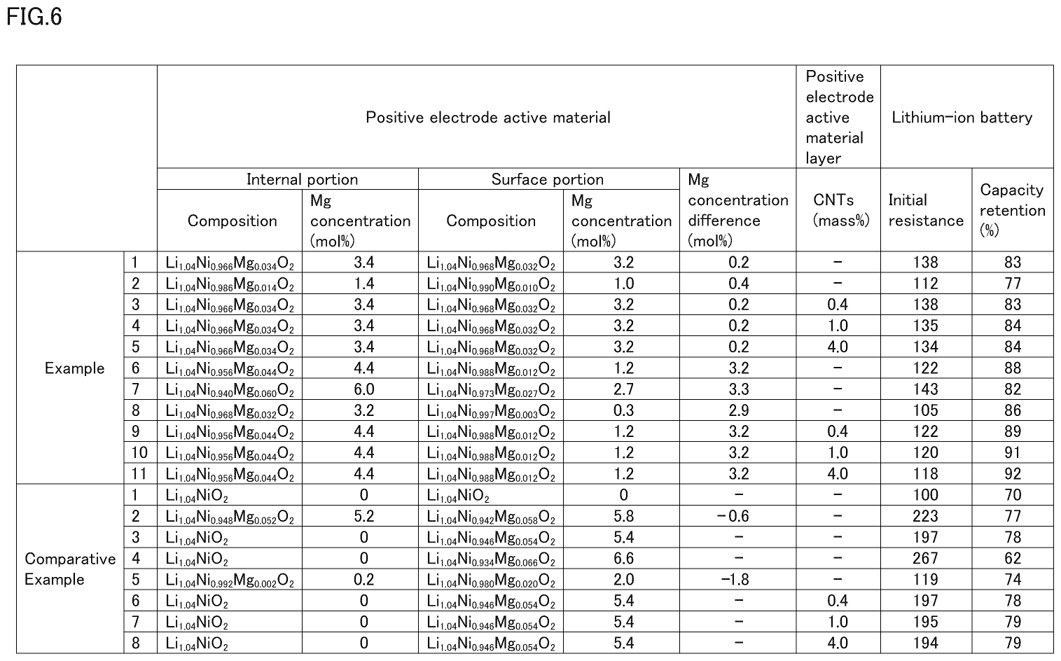

ICP-AES was carried out to check the composition of the internal portion and the surface portion of the positive electrode active material particles of Nos. 1 to 10. As the composition of the internal portion of the positive electrode active material particle, the composition at the center of gravity of the positive electrode active material particle was checked, and as the composition of the surface portion of the positive electrode active material particle, the composition of the outermost surface portion of the positive electrode active material particle was checked. The composition of each positive electrode active material particle is shown in FIG. 6.

### <<Magnesium Concentration>>

TEM-EDX as described above was carried out to check the Mg concentration (mol %) in the internal portion and in the surface portion of the positive electrode active material particles of Nos. 1 to 10. As the Mg concentration in the internal portion of the positive electrode active material particle, the Mg concentration at the center of gravity of the positive electrode active material particle was checked, and as the Mg concentration in the surface portion of the positive electrode active material particle, the Mg concentration in the outermost surface portion of the positive electrode active material particle was checked. The Mg concentration in the internal portion and in the surface portion of each positive electrode active material particle is shown in FIG. 6. In FIG. 6, the difference between the Mg concentration in the internal portion of the positive electrode active material particle and the Mg concentration in the surface portion of the positive electrode active material particle, (internal portion concentration)-(surface portion concentration), is expressed as “Mg concentration difference”.

### <Evaluation>

### (Initial Resistance)

Each test battery was charged to 3.6 V and then, in an environment at room temperature, discharged at a value of current of 10 C for 10 seconds, and the voltage at a time point of 10 seconds after the start of discharging was measured; from the result, IV resistance (electrical resistance) was calculated to determine the initial resistance. Results are shown in FIG. 6. The results are expressed as relative values with respect to the initial resistance of the test battery of Comparative Example 1, which was regarded as 100. When the initial resistance was 150 or less, it was rated as good.

### (Capacity Retention)

After the initial resistance measurement, 100 cycles of charging and discharging were carried out in an environment at room temperature at a constant current of 1 C at a voltage within the range of 3.0 to 4.2 V. After initial charging and discharging, charging and discharging were performed at an electric current of 0.1 C and at a voltage within the range of 3.0 to 4.2 V, and the discharged capacity at this time was defined as initial discharged capacity; and after 100th charging and discharging, charging and discharging were performed at an electric current of 0.1 C and at a voltage within the range of 3.0 to 4.2 V, and the discharged capacity at this time was defined as 100th discharged capacity. The 100th discharged capacity was divided by the initial discharged capacity, and thereby the capacity retention (in percentage) was determined. Results are shown in FIG. 6. A capacity retention of 75% or more was rated as good.

### <Results>

### (Initial Resistance)

Referring to FIG. 6, in Examples where the Mg concentration in the internal portion of the positive electrode active material particle was higher than the Mg concentration in the surface portion of the positive electrode active material particle, the value of initial resistance was good.

Moreover, when comparison is made between Example 1 that included the positive electrode active material particle of No. 2 produced by the doping method, Example 6 that included the positive electrode active material particle of No. 5 produced by the MHP method, and Comparative Example 3 that included the positive electrode active material particle of No. 8 produced by the late-addition method, initial resistance was inhibited the most in Example 6 produced by the MHP method, and initial resistance was the highest in Comparative Example 3 produced by the late-addition method.

### (Capacity Retention)

Referring to FIG. 6, in Examples where the Mg concentration in the internal portion of the positive electrode active material particle was higher than the Mg concentration in the surface portion of the positive electrode active material particle, good capacity retention was maintained even after repeated charging and discharging.

Moreover, when comparison is made between Example 1 that included the positive electrode active material particle of No. 2 produced by the doping method, Example 6 that included the positive electrode active material particle of No. 5 produced by the MHP method, and Comparative Example 3 that included the positive electrode active material particle of No. 8 produced by the late-addition method, capacity retention was the highest in Example 6 produced by the MHP method, and capacity retention was the lowest in Comparative Example 3 produced by the late-addition method.

Further, when Examples 9 to 11 that included the positive electrode active material particle of No. 5 produced by the MHP method as well as CNTs were compared with Example 6 that did not include CNTs, improvement of capacity retention was observed as the content rate of CNTs increased.

Moreover, in Examples 6 to 11 that included the positive electrode active material particle produced by the MHP method, the Mg concentration in the internal portion of the positive electrode active material particle differs greatly from the concentration in the surface portion, as compared with Examples 1 to 5 that included the positive electrode active material particle produced by the doping method.

Although the embodiments of the present disclosure have been described, the embodiments disclosed herein are illustrative and non-restrictive in any respect. The scope of the present disclosure is defined by the terms of the claims, and is intended to encompass any modifications within the meaning and the scope equivalent to the terms of the claims.

What is claimed is:

1. A positive electrode active material particle, wherein
the positive electrode active material particle has a crystal structure of lamellar rock salt type,
the positive electrode active material particle includes a magnesium-containing lithium composite oxide, and
a magnesium concentration in an internal portion of the positive electrode active material particle is higher than a magnesium concentration in a surface portion of the positive electrode active material particle.

2. The positive electrode active material particle according to claim 1, wherein
the magnesium concentration in the internal portion is from 0.5 mol % to 8.0 mol %, and
the magnesium concentration in the surface portion is 5.0 mol % or less.

3. The positive electrode active material particle according to claim 1, wherein a difference between the magnesium concentration in the internal portion and the magnesium concentration in the surface portion is 1.0 mol % or more.

4. A positive electrode comprising the positive electrode active material particle according to claim 1.

5. The positive electrode according to claim 4, further comprising carbon nanotubes.

6. A lithium-ion battery comprising the positive electrode according to claim 4.
